(19) United States
(12) Patent Application Publication
(10) Pub. No.: US 2009/0198465 A1
(43) Pub. Date: Aug. 6, 2009

(54) Proximity sensing systems for manufacturing quality control

(75) Inventors: Doug Dean Decker, Redondo Beach, CA (US); Timothy Jackson Shinbara, El Segundo, CA (US); Joseph Paul Wardell, Cypress, CA (US)

Correspondence Address: BRUCE B. BRUNDA;STETINA BRUNDA GARRED 7 BRUCKER, 75 ENTERPRISE, SUITE 250, ALISO VIEJO, CA, 92656, US

(73) Assignee: NORTHROP GRUMMAN CORPORATION

(21) Appl. No.: 12/012,040

(22) Filed: Jan. 31, 2008

(51) Int. Cl. G06F 19/00

(52) U.S. Cl. 702/84

(57) ABSTRACT

A manufacturing quality control system for monitoring the proximity of a workpiece to a machine tool is disclosed. The system includes a proximity sensor attached to the machine tool for deriving a first distance measurement based upon the distance between the workpiece and the machine tool. A wireless transmitter generates a radio frequency signal including the first distance measurement. A remote data processing device communicates with the wireless transmitter to retrieve the first distance measurement and display various derivations of sensor data.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Technical Field

The present invention generally relates to quality control systems and methods in manufacturing operations. More particularly, the present invention relates to proximity sensing of work pieces from machine tools to maintain close manufacturing tolerances. Further, the present invention relates to proximity sensing systems that can communicate wirelessly or wired with remote data processing devices.

2. Related Art

Composites, which are materials comprised of two or more constituent materials having divergent properties, are frequently utilized in the manufacture of aircraft and other heavy machinery for its light weight, high strength, and extended fatigue life. However, composite materials are often difficult to properly machine because of expansion and movement associated with spring back—a reaction of the material to reduce the stress induced by shaping, and temperature and pressure changes. These dynamic characteristics adversely affect the manufacturability of the material, in that proper alignment to machine tools is difficult to maintain.

One conventional technique to ensure proper machining is the use of a trim fixture vacuum, which is used after positioning the material to stabilize and maintain its initial state relative to the precision tool surface. Positional integrity is maintained throughout the machining operations. In most instances, the machining is performed in an environmentally controlled room by a precision milling machine. Supplemental clamps are typically affixed around the periphery to maintain the vacuum. Trim fixture vacuums significantly improve out-of-tolerance movement during machining, drilling, and trimming operations. One difficulty with sole reliance upon the tool fixture vacuum, however, is that it is uncertain whether all areas of the composite part are properly distanced from the tool surface within the area inside the seal barrier prior to machining. Because this area is obscured and inaccessible, there is difficulty in determining proper contact of the part with respect to the machine tool.

It will be appreciated that validating the conformance of the distance between the composite part and the machine tool is critical, as the automated machines rely upon an initial offset to make all other machining decisions. If a part is not braced in such hidden areas, material may be removed excessively, resulting in a non-conformance. Without verifying the proximity of the material to the machine tool, there is a higher likelihood of it being machined outside the acceptable tolerance. This is particularly problematic in the manufacture of high-quality, tight tolerance parts such as those used in aircraft, where seemingly insignificant discrepancies are anything but. As a consequence, the supply chain is disrupted, production time is increased, and availability is reduced. Furthermore, manufacturing costs are increased because of the added labor and raw material costs. Generally, the quality of the final product is diminished when its constituent parts cannot be accurately and repeatedly produced.

One approach to the foregoing problems involves the use of feeler gauges being placed along the edges of the composite part to determine the amount of space between the tool and the part. Feeler gauges are wedge-like tools having graduated marks corresponding to sections of increasing thickness. This technique is limited, however, in that there is substantial variance from one machinist to the next due to the flexible verification procedures. Furthermore, feeler gauges are limited to those areas that can be accessed, and are also limited by the length constraints of the gauge. Due to the manual nature of this technique, it is difficult to maintain an efficient workflow during manufacturing operations, considering that prior to beginning each machining step, the spacing has to be verified. All of these factors combine to increase the probability that the composite part is out-of-tolerance in relation to the machine tool.

Accordingly, there is a need in the art for an improved manufacturing quality control system. More particularly, there is a need in the art for proximity sensing of work pieces from machine tools to maintain close manufacturing tolerances. Additionally, there is a need for proximity sensing systems that communicate with remote data processing devices over wireless data communication links.

### BRIEF SUMMARY

According to one embodiment of the present invention, a manufacturing quality control system for monitoring the proximity of a workpiece to a machine tool is disclosed. The system may include a proximity sensor attached to the machine tool for deriving a first distance measurement based upon the distance between the workpiece and the machine tool. Additionally, the system may include a wireless transmitter that generates a radio frequency signal or maintain a wired connection to a data processing device. The radio frequency signal may include a first sequence of data representative of the first proximity distance measurement. The wireless transmitter may be provided with the first proximity distance measurement from the proximity sensor. Furthermore, the system may include a remote data processing device in communication with the wireless transmitter. The remote data processing device may include a sensor status module for generating proximity information. The value of the first distance measurement as represented by the first sequence of data derived from the received radio frequency signal may correspond to the proximity information.

In accordance with another embodiment of the present invention, there is disclosed a method for monitoring the proximity of a machine tool to a workpiece during manufacturing. The method begins with generating an analog value on a proximity sensor, in which the analog value corresponds to a first proximity distance measurement. Thereafter, the method continues with converting the analog value to a digital value storable in a data packet, and transmitting the data packet as a wireless signal. The method further includes the step of receiving the data packet, which contains the first distance measurement between the machine tool and the work piece. The first distance measurement is extracted from the data packet, and indicator data is displayed. The indicator data is based upon the first distance measurement.

Thus, the machinist can remotely monitor the positioning of the workpieces to the trim fixture vacuum, increasing manufacturing reliability and product throughput. Multiple proximity sensors may be monitored simultaneously to expand quality control coverage. The present invention will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a block diagram illustrating components of one embodiment of the present invention, including a proximity sensor positioned against a workpiece, a wireless transmitter, and a remote data processing device;

FIG. 2 illustrates an exemplary composite workpiece mounted to a tool fixing vacuum and supported with supplemental clamps;

FIG. 3 is a flowchart describing the method of monitoring the proximity of the machine tool to the workpiece during manufacturing in accordance with another embodiment of the present invention;

FIG. 4 is a block diagram of the proximity sensor in accordance with one embodiment of the present invention;

FIG. 5 is a perspective view of the proximity sensor showing the mechanical features thereof;

FIG. 6 is a block diagram of a remote data processing device including a wireless receiver, a decoder module, a sensor status module, a graphical user interface module, and a display module;

FIG. 7 is an exemplary view of the graphical user interface displaying a time interval graph populated with the values of a first distance measurement at different points in time, as well as an alert indicator and numerical distance values; and

FIG. 8 is an exemplary view of the graphical user interface displaying proximity information associated with a plurality of proximity sensors.

Common reference numerals are used throughout the drawings and the detailed description to indicate the same elements.

### DETAILED DESCRIPTION

The detailed description set forth below in connection with the appended drawings is intended as a description of the presently preferred embodiment of the invention, and is not intended to represent the only form in which the present invention may be constructed or utilized. The description sets forth the functions of the invention in connection with the illustrated embodiment. It is to be understood, however, that the same or equivalent functions and may be accomplished by different embodiments that are also intended to be encompassed within the scope of the invention. It is further understood that the use of relational terms such as first and second and the like are used solely to distinguish one from another entity without necessarily requiring or implying any actual such relationship or order between such entities.

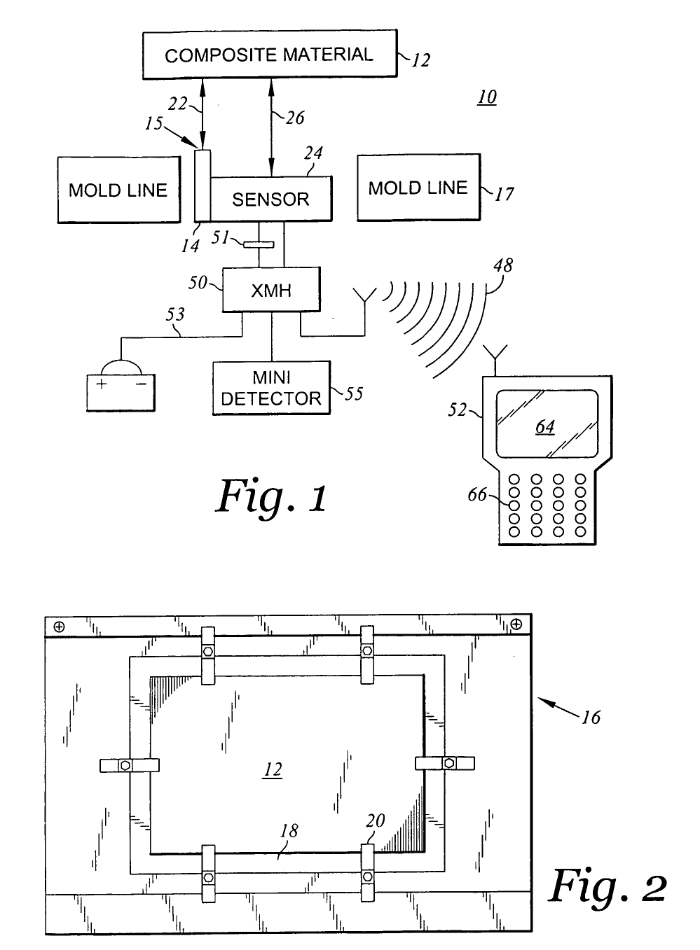

With reference to FIG. 1, according to one embodiment of the present invention, a manufacturing quality control system 10 monitors the proximity of a workpiece 12 to a machine tool 14. As briefly described above in the background, and as further illustrated in FIG. 2, the workpiece 12 is understood to be a composite material mounted to a trim fixture vacuum 16 to stabilize and maintain the proper positioning. The trim fixture vacuum 16 includes a peripheral seal 18 that surrounds the workpiece 12. The workpiece 12 is additionally braced with supplemental clamps 20. As best shown in FIG. 1, the trim fixture vacuum 16 defines a mold line 17, against which the work piece 12 is mounted. It will be appreciated by those having ordinary skill in the art, however, that the foregoing configuration in which the workpiece 12 is mounted to the trim fixture vacuum 16, is presented by way of example only and not of limitation. Any other suitable workpiece support system may be readily substituted without departing from the scope of the present invention. Along these lines, though the present disclosure describes certain aspects in terms of composite materials and operations thereon, it is understood that any other material used in any manufacturing operation may be substituted for the workpiece 12.

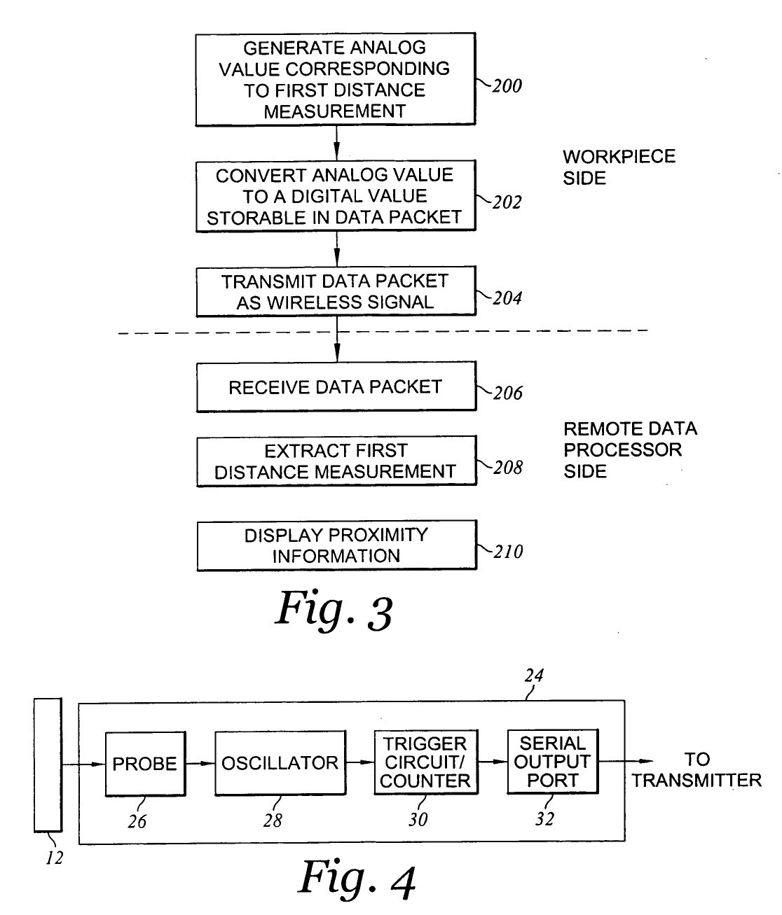

According to another embodiment, and as additionally shown in the flowchart of FIG. 3, there is a method for monitoring the proximity of the machine tool 14 to the workpiece 12 during manufacturing. The method begins with a step 200 of generating an analog value corresponding to a first proximity distance measurement 22 between the workpiece 12 and an operative end 15 of the machine tool 14. A proximity sensor 24 obtains a second proximity distance measurement 25 between the workpiece 12 and the sensor 24, and because the distance between the sensor 24 and the operative end 15 is predetermined, the first distance measurement 22 can be derived.

It is contemplated that proximity sensor 24 is particularly configured for detecting composite materials. A variety of sensor types may be utilized, including, but not limited to: capacitance-type, reed-type, ultrasound-type, and radio frequency-type. Preferably, the proximity sensor 24 has a range of approximately 0 to 0.055 inches, an accuracy of approximately 0.001 inches, and a resolution of approximately 0.000039 inches. Although sensors of other ranges and tolerances may be substituted, in order to properly position the workpiece 12 for tight tolerance manufacturing operations, it is understood that there should not be a substantial deviation from the foregoing operational characteristics. Other preferred operational characteristics of the proximity sensor 24 include a refresh rate of 4 khz (or every 250 microseconds), and resistant to ambient noise having a frequency spectrum lower than 5 Ghz.

As shown in FIG. 4, the proximity sensor 24 includes various modular components that cooperate to provide the distance-measuring features thereof. In particular, the capacitance of a probe 26 is variable as affected by the size of the target or workpiece 12, its dielectric constant, and distance from the probe 26. Generally, as the workpiece 12 approaches the probe 26, its capacitance increases. The probe 26 cooperates with an oscillator 28, which alters its oscillation frequency as the capacitance of the probe 26 is altered. In other words, the oscillation frequency of the oscillator 28 is dependent on the capacitance of the probe 26, and thus dependent on the distance between the probe 26 and the workpiece 12. As indicated above, an analog value corresponding to the first distance measurement 22 is generated according to step 200. In the particular embodiment utilizing the capacitive proximity sensor 24, such analog value corresponds to the oscillation frequency of the oscillator 28. It will be appreciated that other sensor types may produce proportional voltage values as its analog value.

The oscillation signal from the oscillator 28 is fed to a trigger circuit/frequency counter 30. With reference again to the flowchart of FIG. 3, the method continues with step 202 in which the analog value is converted to a digital value storable in a data packet. As utilized herein, the term digital value may also be referred to as a sequence of data. It is contemplated that based upon the oscillation frequency, a corresponding 10-bit hexadecimal number, or first sequence of data, is generated by the trigger circuit/frequency counter 30. In this regard, the first sequence of data is representative of the first distance measurement 22. The trigger circuit/frequency counter 30 samples from the oscillator 28 at predetermined intervals, and transmits the first sequence of data to a serial output port 32. The serial output port 32, in turn, is understood to generate RS-232 compliant serial data packet including the first sequence of data.

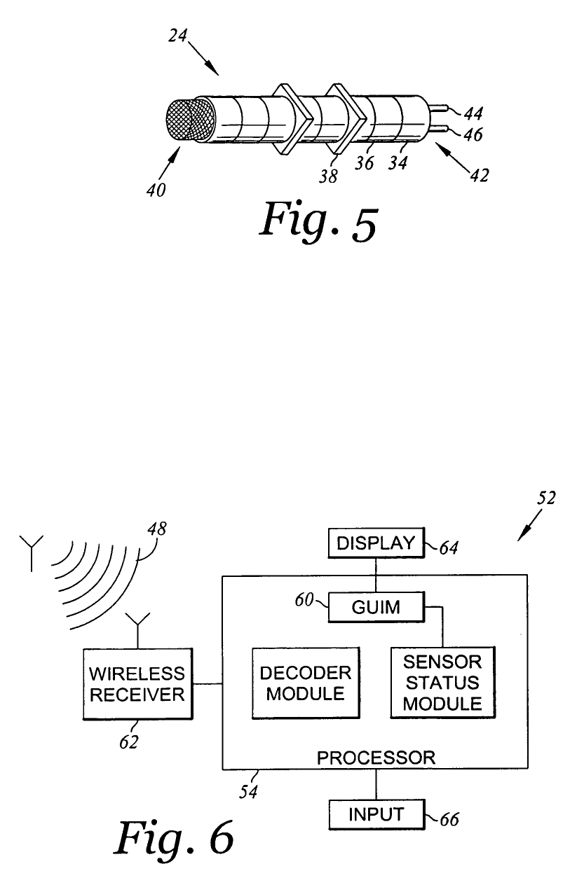

With reference to FIG. 5, the proximity sensor 24 is defined by a generally tubular body 34. The tubular body 34 includes threading 36, which is utilized for securably receiving one or more nuts 38. It is understood that the nuts 38 may be positioned against opposite sides of a mounting panel or the like having an access opening or hole, such that the proximity sensor 24 is effectively mounted thereto. The tubular body 34 is defined by a proximal end 40 including the input of the probe 26, and an opposed distal end 42 including a power input port 44 and a DB-9 serial port 46. It will be recognized by those having ordinary skill in the art that the above-described configuration of the proximity sensor 24 is presented by way of example only, and any other configuration may be substituted. However, it is contemplated that the tubular body 34 be sufficiently resilient such that the internal components are protected against the harsh environment of composite machining including composite material dust, machining coolant, and the force of the tooling vacuum.

Referring to FIGS. 1 and 3, the method continues with step 204 of transmitting the serial data packet as a wireless or radio frequency signal 48. According to an embodiment of the present invention, the manufacturing quality control system 10 includes a wireless transmitter 50 that generates the radio frequency signal 48. As indicated above, the serial data packet includes the first sequence of data that is representative of the first proximity distance measurement 22, which is provided by the proximity sensor 24. In further detail, the wireless transmitter 50 communicates with the serial output port 32 of the proximity sensor 24. As both the serial output port 32 and the wireless transmitter 50 are a Data Terminal Equipment (DTE), a null modem 51 may be utilized to enable serial communications therebetween. The speed of communications between the serial output port 32 and the wireless transmitter 50 may be variously adjusted to accommodate differences in the data processing speed therebetween. Preferably, though optionally, the data transfer rate may be 115200 bits per second. The proximity sensor may be directly hard-wired to a serial port of a data collector as well.

Although the length of the first sequence of data as generated by the proximity sensor 24 is understood to be 10 bits, due to the data size limitations of the serial output port 32, only 8 bits may be transmitted at a time. In this regard, the first sequence of data may be delimited to two bytes of data. As long as the first sequence of data is no greater than 127, or 0111 1111 in binary, then the first byte of data correctly represents the specified number. The second byte of data is also sent, but with a mask represented by the most significant bit. Where the most significant bit is zero, then all data in the second byte is removed as being irrelevant. On the other hand, where the most significant bit is one, and bits 0, 1, and 2 are removed, and bits 7, 8, 9 are transferred to the first byte.

According to one embodiment of the present invention, the wireless transmitter 50 is Bluetooth-compliant. As is well known in the art, Bluetooth is ideal for short-range, low-power data transfer applications where the communicating devices are in relatively close proximity to each other. The range of the wireless transmitter 50 may be approximately 30 feet. Alternative network modalities such as wireless USB, WiFi, and the like are also contemplated.

According to one embodiment of the present invention, power is supplied to the wireless transmitter 50 and the proximity sensor 24 from an on-board battery 53. The on-board battery 53 preferably supplies 18VDC to the proximity sensor 24, while the wireless transmitter 50 is supplied with 5VDC. Alternatively, self-sufficient power modalities are also contemplated for supplying the wireless transmitter 50 and the proximity sensor 24. By way of example only and not of limitation, there may be mechanical actuators linked to the operation of the machine tool 14, which power a miniature generator 55.

As shown in FIGS. 1 and 6, a remote data processing device 52 is in communication with the wireless transmitter 50. With reference to the flowchart of FIG. 3, the method continues with step 206 of receiving the serial data packet including the first sequence of data. The remote data processing device 52 includes a processing module that includes a decoder module 56, a sensor status module 58, and a graphical user interface module 60. The functionality of each of these modules will be described in further detail below. The decoder module 56 communicates with a wireless receiver 62. The wireless receiver 62 is in communication with the wireless transmitter 50, and receives the radio frequency signal 48 for further processing. Results of the data conveyed to the remote data processing device 52 are shown in a display device 64. The operation of the modules may be modified using input keys 66.

According to one embodiment, the remote data processing device 52 is a handheld computer running the Windows Mobile operating system. The above-mentioned modules may be implemented as software code that is downloadable and executable on the Windows Mobile platform. Such software may be programmed in C#, Visual Basic, or any one of numerous programming languages/environments available for the platform. It will be recognized that any other computing platform may be utilized, whether mobility-oriented or not, including Windows XP, Windows XP for TabletPC, PalmOS, and so forth.

As indicated above, the wireless receiver 62 accepts the radio frequency signal 48 as broadcast by the wireless transmitter 50. The radio frequency signal 48 is representative of the serial data packet containing the first sequence of data. According to step 208, the method of monitoring the proximity of the machine tool 14 to the workpiece 12 continues with extracting the first proximity distance measurement 22 from the serial data packet. With further particularity, the decoder module 56 extracts the relevant bytes of data from the serial data packet, as it contains other data useful for error-free communications and troubleshooting, but is otherwise unused in processing the first proximity distance measurement 22. Additionally, the decoder module 56 performs a concatenation of the first transmitted byte and the second transmitted byte, the reverse of the delimiting step described above. Thus, the decoder module 56 produces a 10-bit wide numerical value that is representative of the first distance measurement 22.

Unless there is intimate familiarity with the operation of the proximity sensor 24, the numerical value thus produced by the decoder module 56 has no apparent significance. The decoder module 56 sends the numerical value to the sensor status module 58, where, according to step 210, proximity information is displayed on the display device 64. Generally, it is understood that the proximity information is based upon the first proximity distance measurement 22 and that it holds operational significance to the machinist, as will be further described below. It is expressly contemplated that the proximity information is updated in real time as the radio frequency signal 48 is received by wireless receiver 62.

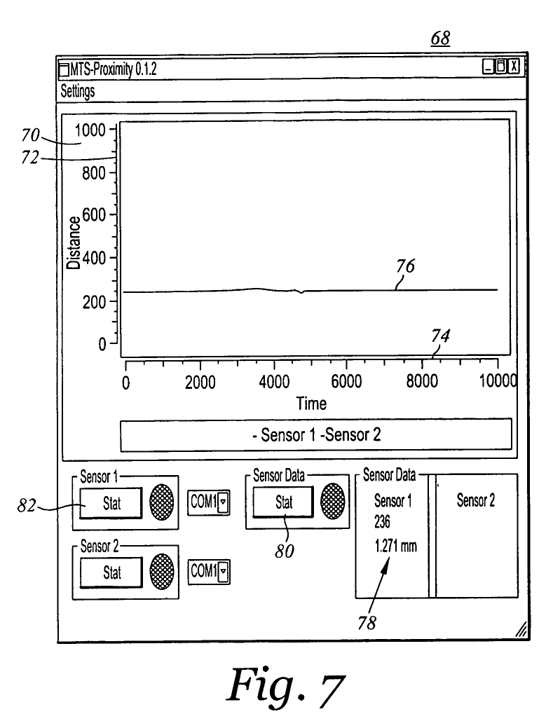

With reference to FIG. 7 and the exemplary user interface 68 generated by the graphical user interface module 60, the proximity information displayed is a time interval graph 70. The Y axis 72 is representative of the distance between the machine tool 14 and the workpiece 12 as measured by the proximity sensor 24, while the X axis 74 the time at which the proximity sensor 24 recorded a measurement, as denoted by the labels therefor. Each display point 76 on the time interval graph 70 is representative of the first distance measurement 22 at a given instant in time. As can be seen, the time interval graph 70 allows for historical tracking of the placement of workpiece 12.

As further illustrated by FIG. 7, the proximity information displayed in the exemplary user interface 68 is a numerical distance value 78 of a most recently acquired one of the first distance measurements 22. The numerical distance value 78 is expressed in fractions of inches in FIG. 7, though alternative measurement units such as SI may be readily substituted, with appropriate conversions. The user interface 68 further includes a file write activation button 80, which writes all of the acquired first distance measurements 22 to a text file readable from other applications on the remote data processing device 52. Additionally, the display and recording of the proximity information particular to the proximity sensor 24 may be activated and deactivated with a sensor start button 82.

Each of the foregoing examples have referred to a single proximity sensor 24 taking measurements and transmitting the same to the remote data processing device 52. It is expressly contemplated, however, that the manufacturing quality control system 10 may include more than one proximity sensor 24, with measurements being simultaneously taken and reported to the remote data processing device 52. As illustrated in FIG. 7, the display of proximity information is particular to a given one of the proximity sensors 24, and the different proximity information types described above may be provided for each of the different proximity sensors 24. Along these lines, where multiple proximity sensors 24 are utilized, each one is assigned a particular identification address that distinguishes it from the others. The above-described Bluetooth protocol has appropriate means of providing such functionality in the form of Media Access Control (MAC) addresses, and such means may be readily implemented on the wireless transmitters 50 by those having ordinary skill in the art.

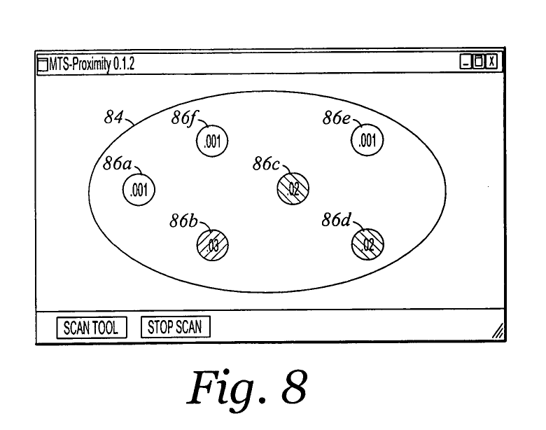

Another visualization technique is contemplated, which is understood to be particularly useful for tracking multiple proximity sensors 24 employed for a single workpiece 12. It will also be appreciated that single proximity sensors 24 employed for a one of a plurality of machining operations may be similarly tracked. As shown in FIG. 8, a part outline 84 generally conforms to the tangible counterpart, that is, the workpiece 12 being machined. The proximity sensors 24 are dispersed around the workpiece 12, as represented by the sensor indicators 86a-86f. In this regard, the sensor indicators 86 and the numbers displayed therein is the proximity information that is generated by the graphical user interface module 60.

The appearance of the sensor indicators 86 is based upon a relationship between the first distance measurement 22 acquired by the corresponding one of the proximity sensors 24, and a predetermined threshold. If the first distance measurement 22 exceeds the threshold, an alert is displayed as the proximity information. In the particular embodiment shown in FIG. 8, the color of the sensor indicators 86 is modified from a first color to a second color. On the other hand, if the first distance measurement 22 remains lower than the threshold, the proximity information displayed is indicative of no fault conditions. More particularly, the sensor indicators 86 where such condition is true remains the first color. Broadly, this type of proximity information may be referred to as “Go-No-Go” signals. Each of the sensor indicators 86 may have displayed therein a numerical value corresponding to the first distance measurement 22 acquired by the respective one of the proximity sensors 24. By way of example only, suppose the threshold is set to 0.01. Because the proximity sensors 24 associated with the sensor indicators 86a, 86e, and 86f have readings less than the threshold (all 0.001), its colors remain the first color. However, because the proximity sensors 24 associated with the sensor indicators 86b, 86c, and 86d have readings greater than the threshold (0.03, 0.02, and 0.02, respectively) the colors thereof are modified to the second color. This visualization technique immediately notifies the machinist of any placement issues prior to machining.

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

What is claimed is:

1. A manufacturing quality control system for monitoring the proximity of a workpiece to a machine tool, comprising:
a proximity sensor attached to the machine tool for deriving a first distance measurement based upon the distance between the workpiece and the machine tool;
a wireless transmitter for generating a radio frequency signal including a first sequence of data representative of the first distance measurement, the wireless transmitter being provided with the first distance measurement from the proximity sensor; and
a remote data processing device in communication with the wireless transmitter and including a sensor status module for generating proximity information from the value of the first distance measurement as represented by the first sequence of data derived from the received radio frequency signal.

2. The manufacturing quality control system of claim 1, wherein the remote data processing device further includes:
a wireless receiver intermittently linked to the wireless transmitter to receive the radio frequency signal; and
a decoder module in communication with the wireless receiver for deriving the first distance measurement from the first sequence of data, the first distance measurement being transmitted to the sensor status module.

3. The manufacturing quality control system of claim 1, wherein the first distance measurement is a proportional analog value representative of the distance between the workpiece and the machine tool, the analog value being converted to the first sequence of data.

4. The manufacturing quality control system of claim 1, further comprising:
a graphical user interface for displaying the proximity information.

5. The manufacturing quality control system of claim 4, wherein the proximity information is updated in real time as the radio frequency signal is received by the remote processing device.

6. The manufacturing quality control system of claim 4, wherein the proximity information displayed by the graphical user interface is a time interval graph with each display point thereof being representative of the first distance measurement at a given instant in time.

7. The manufacturing quality control system of claim 4, wherein the proximity information displayed by the graphical user interface is based upon a relationship between a most recently acquired one of the first distance measurements and a predetermined threshold.

8. The manufacturing quality control system of claim 7, wherein the proximity information is an alert where the most recently acquired one of the first distance measurements exceeds the predetermined threshold.

9. The manufacturing quality control system of claim 7, wherein the proximity information is indicative of no fault conditions where the most recently acquired one of the first distance measurement is less than the predetermined threshold.

10. The manufacturing quality control system of claim 7, wherein the proximity information displayed by the graphical user interface is a numerical distance value of a most recently acquired one of the first distance measurements.

11. The manufacturing quality control system of claim 1, wherein the remote data processing device communicates with a plurality of proximity sensors each having dedicated wireless transmitters, the sensor status module selectively generating proximity information from each of the plurality of proximity sensors.

12. The manufacturing quality control system of claim 1, wherein the radio frequency signal is a Bluetooth-compliant signal.

13. The manufacturing quality control system of claim 1, wherein the proximity sensor and the wireless transmitter are powered by an on-board battery.

14. The manufacturing quality control system of claim 1, wherein the proximity sensor and the wireless transmitter are powered by mechanical assembly actuators linked to the machine tools.

15. A method for monitoring the proximity of a machine tool to a workpiece during manufacturing, the method comprising:
receiving on a remote data processing device a data packet transmitted as a wireless signal, the data packet containing a first distance measurement between the machine tool and the work piece;
extracting the first distance measurement from the data packet; and
displaying proximity information on the remote data processing device, the proximity information being based upon the first distance measurement.

16. The method of claim 15, wherein prior to receiving the data packet, the method further includes:
generating on a proximity sensor an analog value corresponding to the first distance measurement;
converting the analog value to a digital value storable in the data packet; and
transmitting the data packet as the wireless signal.

17. The method of claim 15, wherein the proximity information is displayed on a graphical user interface associated with the remote data processing device

18. The method of claim 17, wherein the proximity information is displayed as a time interval graph with each display point thereof being representative of the first measurement at a given instant in time.

19. The method of claim 17, wherein the proximity information is displayed as an alert where the first distance measurement exceeds a predetermined threshold.

20. The method of claim 17, wherein the proximity information is displayed as a numerical distance value of the first distance measurement.
